(19) United States
(12) Patent Application Publication
(10) Pub. No.: US 2006/0192347 A1
(43) Pub. Date: Aug. 31, 2006

(54) Nitrided material for MLS active layers

(76) Inventor: Frank W. Popielas, Plainfield, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/067,235

(22) Filed: Feb. 25, 2005

(51) Int. Cl. F02F 11/00

(52) U.S. Cl. 277/593

(57) ABSTRACT

A multi-layer steel gasket is produced by cold rolling and nitriding an active layer. The cold rolling provides a desired hardness of the layer, and the nitriding provides a desired strength of the layer to resist cracking and wear.

### TECHNICAL FIELD

The present invention relates to multi-layer steel (MLS) gaskets and in particular to processes that alter the physical characteristics of MLS gasket active layers to improve desirable gasket features.

### BACKGROUND OF THE INVENTION

In recent years, MLS cylinder head gaskets have become a preferred design choice, wherein all (typically at least two) gasket layers have been formed of steel. Beaded layers, also called “active” layers, have generally been fabricated of 301 stainless steel, a relatively robust metal with a commensurately high spring rate, for meeting requisite performance requirements over the useful life of the gaskets.

The trends to reduce fuel consumption and emissions have placed increased demands on the performance on these gaskets. Reducing fuel consumption by using lighter materials in engine cylinder blocks and head assemblies has proven successful, although the lighter alloys used typically experience greater deflection with equivalent cylinder compression ratios. This reduced stiffness may result in additional deflection within the head assembly and cylinder block, resulting in greater motion between the head assembly and cylinder block, and thus, increased demand on a cylinder head gasket to accommodate relative deflection.

Reducing emissions by increasing the engine compression ratio has also proven successful. However, this increase in cylinder pressure typically results in increased motion between the mating surfaces of the head assembly and cylinder block. These contributing factors, and others have resulted in the technology of MLS gaskets becoming an area of constant innovation.

The gasket areas immediately adjacent the circumference of engine cylinder bore apertures are subject to considerably greater stresses for assuring proper sealing than areas of the gasket radially remote from the apertures. These gasket areas immediately adjacent the circumference of engine cylinder bore apertures also experience greater dynamic displacement between the mating surfaces than areas of the gasket radially remote from the apertures.

This displacement between the mating surfaces results in axial motion within the active layers and creates a micro-motion between the active layer and any adjoining surface. This motion typically results in wear of the surfaces at regions of relative motion, commonly called fretting. When the adjoining surface is another layer of the gasket, wear on this layer may result in splitting or cracking of the gasket. When the adjoining surface is one of the mating components, surface wear may result in an ineffective seal. Typically, an elastomeric coating is applied to MLS gasket layers to improve sealability and permit the beaded layer to slide along the mating surface.

Processes that increase the surface strength in order to decrease fretting may undesirably decrease the capacity of a bead portion to accommodate relative displacement between mating surfaces. A bead portion of 301 stainless steel may be heat treated to increase the hardness to a desirable range of between ¾ hard and extra hard (350 to 500 Hv). Typical heat treating processes involve heating steel into a range of 400-450° C. to change the contents and structure of martensite. These heat treating processes may not be compatible with other processes that desirably increase the strength at the surface of the bead portions. What is needed, therefore, is an active layer for a metal gasket that is processed in a manner that affords desirable hardness, surface strength, and spring rate.

### SUMMARY OF THE INVENTION

In one embodiment, the present invention provides a metal layer for a MLS gasket having at least one bead region and a surface subjected to a nitriding process. The metal layer is not subjected to a heat treatment process that heats the metal layer above the critical temperature range.

In another embodiment, a method of producing a MLS gasket with an active layer includes forming at least a half bead in an active layer and nitriding at least a portion of the active layer. The nitriding does not involve heating the metal layer above the critical temperature range.

In a further embodiment, a method of producing at least a portion of a MLS gasket includes cold forming a metal layer, and nitriding at least a portion of the metal layer. The nitriding does not involve heating the metal layer above the critical temperature range.

### BRIEF DESCRIPTION OF THE DRAWINGS

The present invention will now be described, by way of example, with reference to the accompanying drawings, in which:

FIG. 1 is a partial view of a multi-layer steel cylinder head gasket in accordance with an embodiment of the present invention.

FIG. 2 is a sectional view of the gasket of FIG. 1, taken along line 2-2, with the layers separated for clarity.

FIG. 3 is a sectional view, similar to FIG. 2, of an alternative embodiment of a gasket in accordance with an embodiment of the present invention, with the layers separated for clarity.

### DESCRIPTION OF THE PREFERRED EMBODIMENT

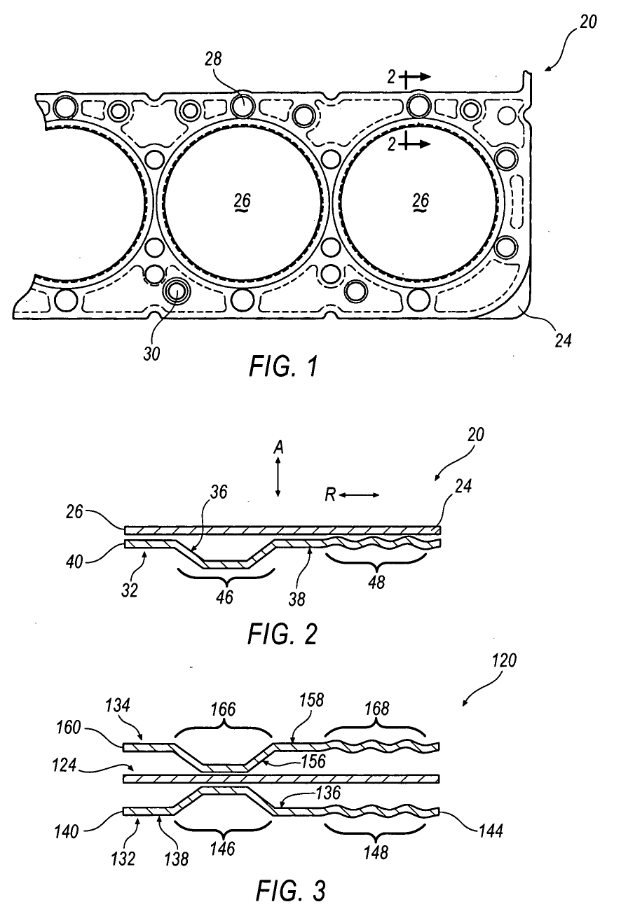

FIG. 1 shows an embodiment of a metal gasket 20 which is a cylinder head gasket. The gasket 20 is positioned between mating surfaces of a cylinder head assembly (not shown) and a cylinder block (not shown) of an internal combustion engine. The gasket 20 includes at least one metal layer 24. As depicted, only the uppermost metal layer 24 is shown. Each metal layer 24 is defined by a plurality of cylinder apertures 26, bolt apertures 28, and jacket apertures 30. Each jacket aperture 30 may transport a cooling fluid, or a lubricating fluid. The metal layers 24 are arranged such that the apertures 26, 28, 30 are generally aligned.

FIG. 2 illustrates that gasket 20 further includes a second metal layer 32. Second metal layer 32 includes a first surface 36, a second surface 38, a cylinder region surface 40, and an outside edge 44. Second metal layer 32 also includes a bead region 46 and a stopper region 48. As illustrated, second metal layer 32 extends in a radial direction R with bead region 46 and stopper region 48 having portions that extend in an axial direction A.

During installation, of the gasket of FIGS. 1 and 2, bead region 46 is partially compressed in the axial direction A, thereby causing bead region 46 to foreshorten in the axial direction A and portions of bead region 46 to experience some movement in the radial direction R. During engine operation, relative movement between the mating surfaces in the axial direction A requires portions of bead region 46 to elastically move in the axial direction A in order to properly seal the mating surfaces. This elastic movement in the axial direction A of bead region 46 causes micro-motion of portions of bead region 46 in the radial direction R relative to surfaces in contact with first surface 36 and second surface 38. When bead region 46 does not have sufficient strength at surfaces 36, 38, cracking and fretting may occur.

To reduce fretting, cracking, and other types of undesirable wear within a MLS gasket, active layers must have sufficient hardness and strength. To insure that a bead region continues to seal during operations with increased axial displacement, the durability of the bead region may be improved.

To obtain a desired hardness for metal layers 32, 132, 134, a cold forming process is used. Preferably a cold rolling process is performed on sheet steel that is later formed into metal layers 32, 132, 134. In using a cold forming process, the hardness of metal layers 32, 132, 134 is increased (due to cold work hardening) to a desirable range of between ¾ hard and extra hard (350 to 500 Hv).

FIG. 3 illustrates an alternative embodiment of the gasket 20 as a gasket 120. Gasket 120 includes a first metal layer 124 interposed between a second metal layer 132 and a third metal layer 134. Second metal layer 132 includes a first surface 136, a second surface 138, a cylinder region surface 140, and an outside edge 144. Second metal layer 132 also includes a bead region 146 and a stopper region 148. Third metal layer 134 includes a first surface 156, a second surface 158, a cylinder region surface 160, and an outside edge 164. Third metal layer 134 also includes a bead region 166 and a stopper region 168.

To increase the strength of metal layers 24, 32, 124, 132, 134, nitriding is performed. While liquid and plasma nitriding may be utilized, gas nitriding is preferably performed. Gas nitriding is a conventional process that exposes a heated metal component to a nitrogen rich media, such as anhydrous ammonia. During nitriding, nitrogen atoms are stripped from the media and combine with iron atoms to produce a diffusion layer within the metal. The metal component is heated (typically below 540° C.) to keep the steel in the current condition and encourage the nitrogen-iron reaction. Therefore, nitriding is accomplished below the critical temperature range for steels such as 301 stainless steel, and does not involve drastic phase changes of the steel.

Nitriding of at least the bead regions 46, 146, 166 forms a diffusion layer of FeₓN that increases the strength of metal layers 32, 132, 134 and thereby reduces fretting. While nitriding is most beneficial within bead regions 46, 146, 166, all portions of metal layers 32, 132, 134 are preferably nitrided.

Nitriding, pursuant to the invention, obtains high surface hardness, increases wear resistance, and improves fatigue life. Nitriding also increases the material's durability and resistance to cracking. While the metal layers 32, 132, 134 are preferably coated with known elastomer compounds to improve sealability, the nitrided active layers reduce the reliance on the elastomer to maintain an effective seal throughout the life of the gasket. Improved gaskets produced in accordance with the present invention can also be used to seal between cylinder head assemblies and exhaust manifolds, since the hardened, nitrided layer would experience reduced fretting in other applications as well.

Plasma, or ion, nitriding does not involve a separate heating of the components to be nitrided, but rather is performed by placing a metal component in a vacuum and using high-voltage electrical energy to form a plasma through which nitrogen atoms are accelerated to impinge on the component. While this impingement of nitrogen atoms on the surface of the metal component will heat the component, plasma nitriding offers a low temperature option for nitriding that may result in less distortion. Masking techniques may be employed to selectively nitride portions of a metal component.

The nitriding process may be performed before or after the cold forming process. The cold forming process may also be employed to form at least a portion of bead regions 46, 146, 166. Bead regions 46, 146, 166 may be half beads, full beads, or other distortions formed within a planar gasket that experience a deflection and provide a sealing contact as the gasket 20 is compressed between the mating surfaces. Metal layers 32, 132, 134 are typically referred to as active layers due to the movement experienced by the bead regions 46, 146, 166.

While the invention has been described with respect to specific examples including preferred modes of carrying out the invention, those skilled in the art will appreciate that there are numerous variations and permutations of the above described systems and techniques that fall within the spirit and scope of the invention as set forth in the appended claims.

What is claimed is:

1. A multi-layer steel gasket, comprising:
a metal layer having at least a bead region and a surface subjected to a nitriding process, wherein said metal layer is not subjected to a heat treatment process that heats said metal layer above the critical temperature range.

2. The multi-layer steel gasket of claim 1, wherein said metal layer is cold rolled to increase hardness.

3. The multi-layer steel gasket of claim 2, wherein said hardness is in the range of about Hv=350 to about Hv=500.

4. The multi-layer steel gasket of claim 1, wherein said metal layer is formed of 301 stainless steel.

5. The multi-layer steel gasket of claim 1, wherein said gasket selectively seals between a head assembly and an exhaust assembly.

6. The multi-layer steel gasket of claim 1, wherein said gasket selectively seals between a head assembly and cylinder block.

7. The multi-layer steel gasket of claim 6, further comprising a stopper positioned around said aperture.

8. The multi-layer steel gasket of claim 1, wherein said bead region includes a full bead.

9. A method of producing a MLS gasket with an active layer that is not heat treated, the method comprising the steps of:
forming at least a half bead in an active layer; and
nitriding at least a portion of said active layer, wherein said nitriding does not involve heating said metal layer above the critical temperature range.

10. The method of claim 9, wherein said nitriding includes gas nitriding.

11. The method of claim 9, wherein said nitriding includes plasma nitriding.

12. The method of claim 9, wherein said nitriding includes liquid nitriding.

13. The method of claim 9, further comprising the step of forming a full bead in said active layer.

14. The method of claim 9, further comprising the step of forming at least a half bead in said active layer.

15. The tuning cable of claim 9, further comprising the step of work hardening said metal layer to increase hardness.

16. A method of producing at least a portion of a MLS gasket comprising the steps of:
cold forming a metal layer; and
nitriding at least a portion of said metal layer, wherein said nitriding does not involve heating said metal layer above the critical temperature range; and

17. The method of claim 16, wherein said step of cold forming is performed before said step of nitriding.

18. The method of claim 16, wherein said step of nitriding is performed before said step of cold forming.

19. The method of claim 16, wherein the step of cold forming further comprises cold rolling.

20. The method of claim 16, further comprising forming a bead portion in said metal layer to produce an active layer.
